(19) United States
(12) Patent Application Publication
(10) Pub. No.: US 2025/0339252 A1
(43) Pub. Date: Nov. 6, 2025

(54) EASILY DETACHABLE MEDICAL OPENING AND SUCTION DEVICE

(71) Applicant: Sang Hoon Ahn, Sejong (KR)

(72) Inventor: Sang Hoon Ahn, Sejong (KR)

(21) Appl. No.: 18/280,447

(22) PCT Filed: Mar. 14, 2022
(86) PCT No.: PCT/KR2022/003492

§ 371 Date: Apr. 19, 2024

(30) Foreign Application Priority Data
May 18, 2021 (KR) 10-2021-0063796

(51) Int. Cl. A61C 17/08

(52) U.S. Cl. CPC A61C 17/08

(57) ABSTRACT

The present invention relates to an easily detachable medical opening and suction device that is configured to allow a fixed or flexible mouth opening part adapted to hold a patient' mouth open during dental treatment and a suction part adapted to suck saliva, water, and cut tooth pieces from the patient's mouth to be detachably coupled to each other with ease.

### TECHNICAL FIELD

The present invention relates to a door for a showcase, and more particularly, to an automatic foldable door of a detachable type for a showcase that is installed on a front surface of an open-type showcase with no door, and is automatically folded or unfolded according to detection of a sensor to keep an inside of the showcase more clean and fresh, as well as reducing an amount of electricity used, in which if a certain foldable screen is braked by an external force while a plurality of foldable screens are folding or unfolding, operation of the certain foldable screen can be temporarily stopped for safety of a user.

### BACKGROUND ART

Generally, a patient has to open his or her mouth for a long time when he or she receives dental treatment or surgery. As a result, a burden may be applied to his or her jaw joint, thereby making him or her feel uncomfortable owing to jaw trembling or a sound generated from the jaw.

During the dental treatment or surgery, further, a suction tip is located in the oral of the patient to suck saliva, blood, water, tartar, and cut tooth pieces from the oral.

In most cases, the suction tip is bent and placed over the patient's mouth, and otherwise, a dentist directly holds a suction unit to place the suction tip in the mouth.

If the suction tip is bent and thus used, however, the suction unit is held by the dentist and then located around soft palate to suck the saliva, water, and the like staying on the soft palate, which causes inconveniences of use.

If the dentist is unskilled in using the suction tip, the patient's soft tissues are sucked to the suction tip, thereby causing the patient's hurts, and further, if the suction tip comes into contact with the soft palate or uvula of the patient, gag reflex may occur.

To solve such problems, there are suggested Korean Patent No. 10-1363054 (hereinafter, referred to as Literature 1), U.S. Patent Application No. 2014-0356802 (hereinafter, referred to as Literature 2), Korean Patent No. 10-1522314 (hereinafter, referred to as Literature 3), and Korean Patent No. 10-2068080 (hereinafter, referred to as Literature 4).

The invention of the literature 1 relates to a mouth opening device for dental treatment that has functions of opening a patient's mouth and fixing a suction tube for sucking saliva from the mouth during the dental treatment.

According to the literature 1, the mouth opening device for dental treatment has side walls formed on both ends of a base to prevent teeth from escaping therefrom. If a size of a molar is relatively larger than the average size of a molar, the molars are blocked by the side walls so that it is hard to locate the molars on teeth mounting and supporting portions. Further, if the patient's mouth is a little open during the use of the mouth opening device, the mouth opening device escapes from the teeth and falls toward the uvula, thereby causing gag reflex.

The invention of the literature 2 relates to an oral lighting device that is detachably mounted on a patient's teeth to emit light, thereby eliminating the inconveniences caused by the shadow generated by a dentist's hand and equipment located between an external light source and the patient's oral.

According to the literature 2, the oral lighting device irradiates the light onto the whole region of the oral, so that it is impossible to efficiently use the light upon the treatment of a local region. Further, a suction tip is fitted to a retention element protruding from the side of the oral lighting device, but the suction tip comes into contact with the soft palate or uvula, so that the suction tip has to be inconveniently controlled in position consistently.

The invention of the literature 3 relates to a suction mouth prop that holds a patient's mouth open, thereby enabling gentle suction and clear view of a dentist and preventing soft tissue suction or damage from occurring upon the suction.

According to the literature 3, a tube to which the suction tip is coupled passes through a connection portion of the suction mouth prop and is then placed over the patient's mouth, but only if the patient opens his or her mouth a little, the mouth prop may escape from the teeth easily, thereby causing the dentist to periodically monitor or control the position thereof.

The invention of the literature 4 relates to a gum support part insertion type mouth prop that adjusts a gap in accordance with a patient's mouth size, thereby being used with compatibility to patients who have various mouth sizes.

According to the literature 4, the mouth prop makes a dentist control a rotating and transferring pivot in accordance with the patient's mouth size to inconveniently adjust a length of a hinge link every time.

### BACKGROUND ART LITERATURE

(Literature 1) Korean Patent No. 10-1363054
(Literature 2) U.S. Patent Application No. 2014-0356802
(Literature 3) Korean Patent No. 10-1522314
(Literature 4) Korean Patent No. 10-2068080

### DISCLOSURE

### Technical Problem

Accordingly, the present invention has been made in view of the above-mentioned problems occurring in the related art, and it is an object of the present invention to provide a medical opening and suction device that is capable of being easily detachable.

It is another object of the present invention to provide a medical opening and suction device that is capable of allowing a mouth opening part serving to hold a patient's mouth open and suck a liquid in the mouth and a suction part coupled to the mouth opening part to provide a suction force to be detachably attached to each other with ease.

It is yet another object of the present invention to provide a medical opening and suction device that is capable of providing elasticity to a mouth opening part having second concave portions and second apertures, so that when the mouth opening part is mounted on a patient's mouth, the burden of his or her jaw joint is minimized.

It is still another object of the present invention to provide a medical opening and suction device that is capable of sucking and removing saliva, water, and the like automatically, without any separate suction tip, while not sucking soft tissues in the mouth.

### Technical Solution

To accomplish the above-mentioned objects, according to the present invention, an easily detachable medical opening and suction device may include a mouth opening part (1) put in a patient's mouth to seat the patient's teeth thereonto in such a way as to hold the patient's mouth open and having a hole formed therein to suck a liquid in the mouth; and a suction part (2) having guide portions (410) whose one end detachably coupled to the other end of the mouth opening part (1), a tube (T) coupled to the other end of the guide portions (410), and a suction unit coupled to the other end of the tube (T) to provide a suction force.

The mouth opening part (1) may include: a first body (100) having first concave portions (120 and 120a) onto which occlusal surfaces are locked and a first aperture (110) to which the liquid is sucked; a second body (200) extending from the other end of the first body (100) and having mounting portions (230 and 230a) onto which the teeth are seated, first support portions (231 and 231a) protruding from the side surfaces of the mounting portions (230 and 230a) and located between a teeth arrangement and the buccal mucosa, and handle portions (240 and 240a) extending from the mounting portions (230 and 230a); and a third body (300) having a coupling groove (310) to which the suction part (2) is detachably coupled.

Further, the mouth opening part (1) may include second concave portions (210 and 210a) formed between the first body (100) and the second body (200) and second apertures (220 and 220a) formed on the second body (200) to thus apply elasticity to the handle portions (240 and 240a).

The mounting portions (230 and 230a) may have first non-slip portions (232 and 232a) protruding therefrom to prevent the teeth from slipping therefrom.

The handle portions (240 and 240a) may have second non-slip portions (241 and 241a) protruding therefrom to prevent a hand holding the mouth opening part (1) from slipping therefrom.

The mouth opening part (1) may have extending portions (250 and 250a) extending from one side of the mounting portions (230 and 230a) and the handle portions (240 and 240a) to extend an area onto which the teeth are seated.

The suction part (2) may have the guide portions (410) formed on one end thereof, third apertures (420) formed between the neighboring guide portions (410), and first protrusions (411) protruding from the inner surfaces of the guide portions (410) in such a way as to be detachably coupled to the other end of the mouth opening part (1).

### Effectiveness of Invention

According to the present invention, the easily detachable medical opening and suction device allows the mouth opening part serving to hold the patient's mouth open and suck a liquid in the mouth and the suction part coupled to the mouth opening part to provide a suction force to be detachably attached to each other with ease, so that the suction part coupled to the mouth opening part is separated and freely used, without having any separate suction tip, thereby enabling dental treatment or surgery to be gently conducted.

Further, the medical opening and suction device provides elasticity to the mouth opening part having the second concave portions and the second apertures, so that when the mouth opening part is mounted on a patient's mouth, the burden of his or her jaw joint is minimized, and his or her mouth is kept to the open state comfortably and safely.

Furthermore, the medical opening and suction device does not suck soft tissues by means of the first aperture of the mouth opening part, so that the first aperture is not blocked through the soft tissues, thereby automatically sucking and removing saliva, water, and the like consistently.

Accordingly, the easily detachable medical opening and suction device according to the present invention is used even by one dentist, without any assistant who performs suction, so that as the dentist has a clear view, he or she can perform fluoride application, self-cured resin treatment, and the like.

### BRIEF DESCRIPTION OF DRAWINGS

FIG. 1 is an exploded perspective view showing an easily detachable medical opening and suction device according to the present invention.

FIG. 2 is a front view showing a mouth opening part according to the present invention.

FIG. 3 is a front view showing a suction part according to the present invention.

FIG. 4 is a sectional view showing a state where the mouth opening part and the suction part are coupled to each other.

FIG. 5 is a front view showing another example of the mouth opening part according to the present invention.

FIG. 6 is a left side view showing yet another example of the mouth opening part according to the present invention.

FIG. 7 is a front view showing still another example of the mouth opening part according to the present invention.

### EXPLANATIONS OF REFERENCE NUMERALS

1: Mouth opening part
100: First body
110: First aperture
120, 120a: First concave portion
200: Second body 201: First hole
210, 210a: Second concave portion
220, 220a: Second aperture
221, 221a: Second protrusion
230, 230a: Mounting portion
231, 231a: First support portion
232, 232a: First non-slip portion
240, 240a: Handle portion
241, 241a: Second non-slip portion
250, 250a: Extending portion
300: Third body
310: Coupling groove
2: Suction part
410: Guide portion
411: First protrusion
413: Third hole
412: Second hole
414: Fourth hole
420: Third aperture
T: Tube

### BEST MODE FOR INVENTION

Hereinafter, the present invention will now be described in detail by way of particular embodiments.

Objects, characteristics and advantages of the present invention will be more clearly understood from the detailed description as will be described below and the attached drawings.

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

Therefore, it should be understood that the present invention is not limited by the embodiments as will be discussed later and has all modifications in the technical spirit and scope of the present invention. That is, the present invention may be freely modified by those of ordinary skill in the art through addition, change, and deletion of the components thereof within the scope of the invention limited by the claims appended hereto, and the modifications may be within the scope of the claims.

The present invention may be modified in various ways and may have several exemplary embodiments. Specific exemplary embodiments of the present invention are illustrated in the drawings and described in detail in the detailed description. In the drawings, dimensions of elements or relative dimensions of elements may be exaggerated for clarity of illustration. Further, the shapes of elements as shown in the drawings may be somewhat varied according to the changes in their manufacturing process.

In the description, therefore, the disclosed embodiments may not be limited to the shapes as shown in the drawings unless otherwise defined and they may have some variations.

Further, the embodiments of the present invention may be combined with other embodiments unless there are obvious objections. In specific, any desirable or advantageous characteristics may be combined with other desirable or advantageous characteristics. Various aspects, characteristics, and embodiments of the present invention may be used alone or in combinations.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification. An expression referencing a singular value additionally refers to a corresponding expression of the plural number, unless explicitly limited otherwise by the context.

In explaining the example embodiments, further, detailed description on known elements or functions will be omitted if it is determined that such description will interfere with understanding of the embodiments.

### First Embodiment

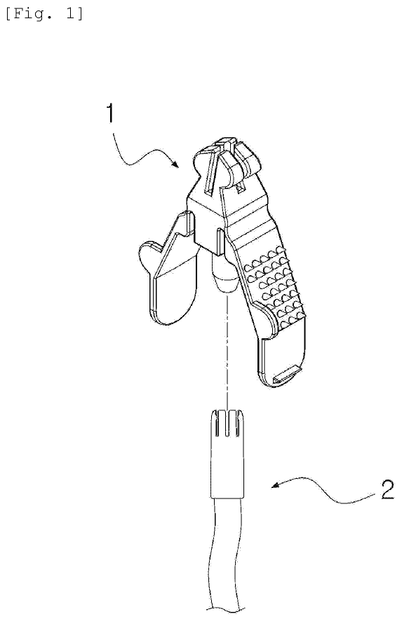

As shown in FIG. 1, an easily detachable medical opening and suction device (hereinafter, referred to as ‘medical opening and suction device’) according to the present invention includes a mouth opening part 1 and a suction part 2.

The mouth opening part 1 is introduced in a patient's mouth to seat the patient's teeth thereonto in such a way as to hold the patient's mouth open and has a hole formed therein to suck and remove a liquid such as saliva, water, and the like and foreign substances such as tartar, cut tooth pieces, and the like.

In this case, the mouth opening part 1 is desirably used for a human, but of course, it may be applied for mammal, reptile, etc.

Further, the mouth opening part 1 is made of synthetic resin, metal, or biodegradable resin by means of injection molding. Desirably, the mouth opening part 1 is made of synthetic resin for medical use or not harmful to human bodies.

For example, the synthetic resin for medical use or not harmful to human bodies is any one selected from polypropylene (PP), transparent-impact resistance polypropylene (TIPP), polycarbonate (PC), polyethylene terephthalate (PET), polyethersulfone (PES), polyphenylsulfone (PPSU), polyoxymethylene (POM), and silicone resin.

If one-time mouth opening part 1 is used, it is desirable that the mouth opening part 1 be made of polyoxymethylene.

If the mouth opening part 1 is sanitized and then used, it is desirable that it be made of any one of polypropylene, polyethersulfone, and polyphenylsulfone.

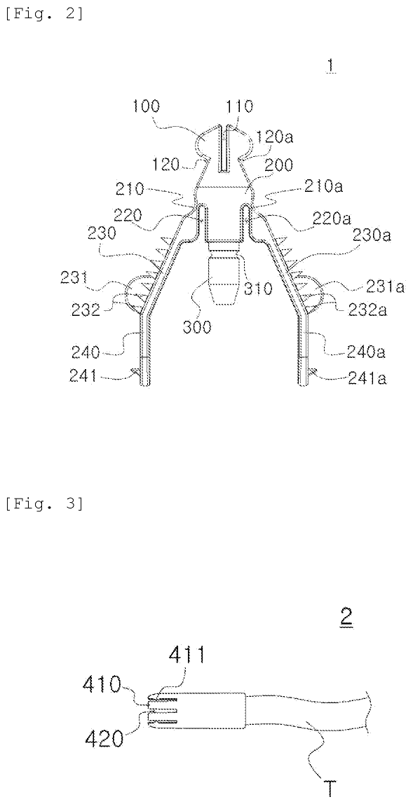

In specific, as shown in FIGS. 1 and 2, the mouth opening part 1 includes a first body 100, a second body 200, and a third body 300.

As shown in FIG. 2, the first body 100 protrudes from the sides of one end thereof and thus has the shape of a pointed arch or the shape of a space

[symbol]

In this case, as the first body 100 protrudes from the sides of one end thereof, the first body 100 has first concave portions 120 and 120a.

When the mouth opening part 1 is bitten by the patient's teeth, the first concave portions 120 and 120a are placed over the teeth located at the mouth's innermost portion constituted of hard tissues, while having small soft tissues, and accordingly, one end of the first body 100 is located on soft tissues behind the innermost teeth of the mouth.

For example, if the first concave portions 120 and 120a are placed over the occlusal surfaces as the ends of the innermost molars of the mouth, a negative pressure is generated from the first concave portions 120 and 120a to allow a liquid such as saliva, water, and the like to be consistently sucked and removed through a first aperture 110, without any blocking of the first aperture 110 through soft tissues such as tongue, buccal mucosa, and the like.

The first aperture 110 is formed on one end of the first body 100 to suck the liquid and has the shape of a straight line, a long and narrow rectangle, a circle, or a pin hole.

As shown in FIG. 2, desirably, the first aperture 110 has the shape of the long and narrow rectangle, and accordingly, even if the soft tissues are attached to the first aperture 110, a given gap is generated to allow the liquid to be consistently sucked and removed through the first aperture 110.

When the first aperture 110 is viewed on plane, further, it becomes any one selected from a straight line type aperture with a single line, a cross type aperture formed by passing a single line through another line, and a radial type aperture formed by passing a single line through two or more lines.

The line may be linear or non-linear.

The first body 100 has a suction hole formed therein in such a way as to allow the rear end to be connected to a first hole 201 as will be discussed later, so that the suction hole serves to suck and remove the liquid.

The second body 200 extends from the other end of the first body 100 and has the first hole 201 formed therein. In this case, the liquid sucked along the suction hole passes through the first hole 201 and is then discharged through a discharge hole formed on the other end of the first hole 201.

When the second body 200 is viewed on the front surface thereof, as shown in FIG. 2, the second body 200 has mounting portions 230 and 230a with slant surfaces formed on both sides thereof. In this case, as shown in FIG. 2, the mounting portions 230 and 230a are symmetrically formed on both sides of the second body 200 around the first body 100.

The patient's teeth are seated onto the mounting portions 230 and 230a. As the patient's teeth are seated onto the mounting portions 230 and 230a, in this case, the burden of his or her jaw joint is minimized, and further, his or her mouth is kept open comfortably and safely.

To prevent the patient's teeth from slipping or escaping from the mounting portions 230 and 230a, in this case, the mounting portions 230 and 230a have first non-slip portions 232 and 232a protruding from the surfaces on which the teeth are seated.

The first non-slip portions 232 and 232a have the shapes of protrusions, concave-convex portions, or waves, but they may not be limited thereto.

In this case, the first non-slip portions 232 and 232a may not be limited specifically in size and number.

Further, the mounting portions 230 and 230a have first support portions 231 and 231a protruding from side surfaces thereof.

The first support portions 231 and 231a protrude horizontally from the side surfaces of the other end of the mounting portions 230 and 230a, and when the mouth opening part 1 is fitted to a neutral zone and thus rotates in the mouth, the first support portions 231 and 231a serve to prevent the mouth opening part 1 from deeply entering the mouth or escaping from the mouth to the outside.

In this case, the neutral zone represents a space between a teeth arrangement and the buccal mucosa.

In this case, the teeth arrangement comes into contact with the inner surfaces of the first support portions 231 and 231a, and the buccal mucosa comes into contact with the outer surfaces of the first support portions 231 and 231a.

For example, if the mouth opening part 1 is fitted to the left neutral zone of the patient, the left upper jaw teeth of the patient are seated onto the mounting portion 230a, and the left lower jaw teeth of the patient are seated onto the mounting portion 230. In this case, the first support portion 231a is fitted to the neutral zone located on the left upper jaw of the patient, and the first support portion 231 is fitted to the neutral zone located on the left lower jaw of the patient.

In this case, the first concave portion 120a is placed over the occlusal surface of the innermost molar of the left upper jaw of the patient, and the first concave portion 120 is placed over the occlusal surface of the innermost molar of the left lower jaw of the patient.

For example, if the mouth opening part 1 is fitted to the right neutral zone of the patient, the right upper jaw teeth of the patient are seated onto the mounting portion 230, and the right lower jaw teeth of the patient are seated onto the mounting portion 230a. In this case, the first support portion 231 is fitted to the neutral zone located on the right upper jaw of the patient, and the first support portion 231a is fitted to the neutral zone located on the right lower jaw of the patient.

In this case, the first concave portion 120 is placed over the occlusal surface of the innermost molar of the right upper jaw of the patient, and the first concave portion 120a is placed over the occlusal surface of the innermost molar of the right lower jaw of the patient.

Further, handle portions 240 and 240a extend from the other end of the first support portions 231 and 231a.

The handle portions 240 and 240a are held by the patient or dentist to insert the mouth opening part 1 into the patient's mouth.

In this case, the handle portions 240 and 240a have second non-slip portions 241 and 241a protruding from the surfaces with which the patient or dentist's hand comes into contact to thus prevent the hand from slipping therefrom.

As shown in FIG. 2, the mouth opening part 1 having the first body 100 and the second body 200 has the shape similar to a letter A.

The third body 300 extends from the center of the other end of the second body 200.

In this case, the third body 300 has a coupling groove 310 adapted to allow the suction part 2 as will be discussed later to be easily detachable therefrom.

The third body 300 has the first hole 201 extending from the second body 200 at the interior thereof and the discharge hole at the other end thereof.

To allow the suction part 2 to be slidingly fitted to the third body 300, further, the third body 300 has the shape of a cylinder extending from the center of the other end of the second body 200 and the shape of a cone extending from the other end of the cylinder.

The coupling groove 310 is formed on the cylinder of the third body 300 and adapted to lockedly fit first protrusions 411 of the suction part 2 thereto.

The suction part 2 is detachably coupled to the mouth opening part 1 and includes a tube T and a suction unit.

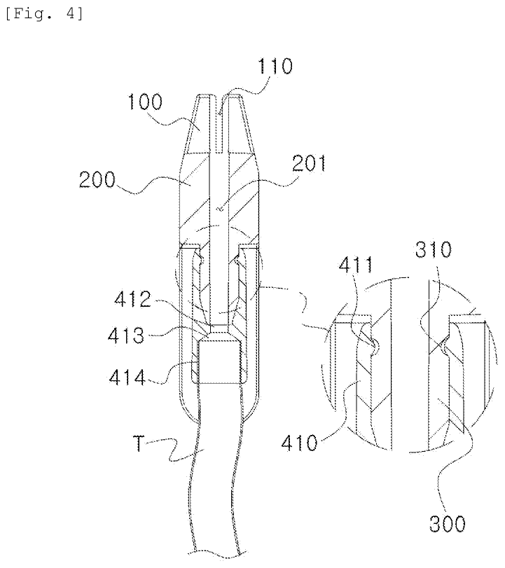

In specific, as shown in FIG. 3, the suction part 2 has guide portions 410 and the tube T coupled to the other end of the guide portions 410.

The suction unit is coupled to the other end of the tube T to provide a suction force.

In this case, the tube T is made of synthetic resin with general flexibility, and a wire made of metal with plasticity is integrally formed inside the tube T so that the tube T is kept to a deformed shape after deformed to a desired shape upon dental treatment or surgery.

The suction part 2 has a space formed therein, and the space is cylindrical.

In this case, the suction part 2 has the guide portions 410 and third apertures 420 formed on one end thereof so that the suction part 2 is detachably coupled to the mouth opening part 1 with ease.

In this case, the guide portions 410 and the third apertures 420 are alternately formed on one end of the suction part 2, so that one end of the suction part 2 is formed separately.

In this case, each guide portion 410 has the first protrusion 411 protruding from the inner surface thereof.

In this case, the first protrusions 411 have the shapes of semi-circles in such a way as to slide along the outer peripheral surface of the third body 300 and to be thus lockedly fitted to the coupling groove 310.

In this case, when one end of the suction part 2 slides along the outer peripheral surface of the third body 300, even if the inner diameter of one end of the suction part 2 is smaller than the outer diameter of the third body 300, the guide portions 410 and the third apertures 420 are alternately formed on one end of the suction part 2, so that the inner diameter of one end of the suction part 2 is expanded to the same size as the outer diameter of the third body 300, fitted to the coupling groove 310, and then returns to its original size, thereby completing the coupling between the suction part 2 and the mouth opening part 1.

Contrarily, even when the suction part 2 escapes from the mouth opening part 1, the suction part 2 slides along the outer peripheral surface of the third body 300 and thus easily escapes therefrom.

Therefore, the suction part 2 is detachably coupled to the mouth opening part 2 with ease in the above-mentioned methods. As a result, the suction part 2 coupled to the mouth opening part 1 is separated and freely used, without having any separate suction tip, so that advantageously, dental treatment or surgery can be gently conducted.

During the coupling process between the mouth opening part 1 and the suction part 2, under the above-mentioned configuration, the mouth opening part 1 does not enter the mouth, and during the separating process therebetween, the mouth opening part 1 does not escape from the mouth.

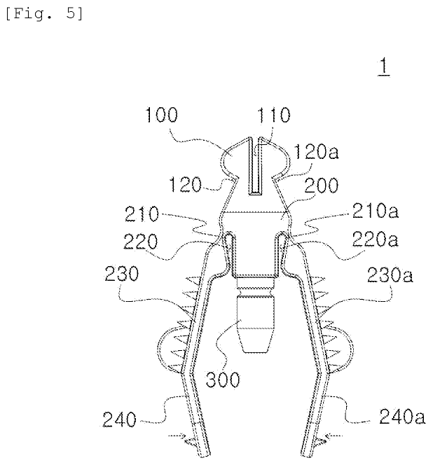

To minimize a clearance between the suction part 2 and the third body 300, as shown in FIG. 4, the inner space of one end of the suction part 2 has the shape corresponding to the outer shape of the third body 300, so that no loose portion exists when the suction part 2 is fitted to the mouth opening part 1, thereby improving a contact force between the suction part 2 and the mouth opening part 1 to thus keep the negative pressure and preventing the suction force from being lowered.

When the liquid is sucked after the suction part 2 has been fitted to the mouth opening part 1, in specific, if water exists on the contacted surface between the mouth opening part 1 and the suction part 2, a water curtain is formed to thus improve the contact force therebetween to keep the negative pressure.

The suction part 2 has a fourth hole 414 formed on the other end thereof to couple the tube T thereto.

The inner diameter of the fourth hole 414 is equal to the outer diameter of the tube T.

Further, a second hole 412 and a third hole 413 are formed between the inner space formed on one end of the suction part 2 and the fourth hole 414 formed inside the other end of the suction part 2.

The second hole 412 comes into contact with the discharge hole formed on the other end of the third body 300.

Further, the inner diameter of the second hole 412 is equal to or smaller than the inner diameter of the discharge hole of the third body 300, and desirably, the inner diameter of the second hole 412 is smaller than the inner diameter of the discharge hole of the third body 300, thereby improving the suction force.

The third hole 413 is formed between the second hole 412 and the fourth hole 414.

Accordingly, the medical opening and suction device according to the present invention is configured to allow the suction part 2 to be easily detachable from the mouth opening part 1, so that if necessary, the suction part 2 is separated from the mouth opening part 1 to allow the dentist to suck and remove the liquid through the suction part 2.

### Second Embodiment

The medical opening and suction device according to the first embodiment of the present invention further includes second concave portions 210 and 210a and second apertures 220 and 220a to apply elasticity to the mouth opening part 1.

Accordingly, the medical opening and suction device according to the second embodiment of the present invention is the same as according to the first embodiment of the present invention, except the second concave portions 210 and 210a and the second apertures 220 and 220a, and therefore, repeated explanations will be omitted.

As shown in FIG. 2, the second concave portions 210 and 210a are concavely formed on both sides of the second body 200 located between the first body 100 and the mounting portions 230 and 230a.

As shown in FIG. 2, the second apertures 220 and 220a are formed to the shapes of slits on the other end of the second body 200 around the third body 300. In this case, the second apertures 220 and 220a are symmetrically formed to each other around the third body 300.

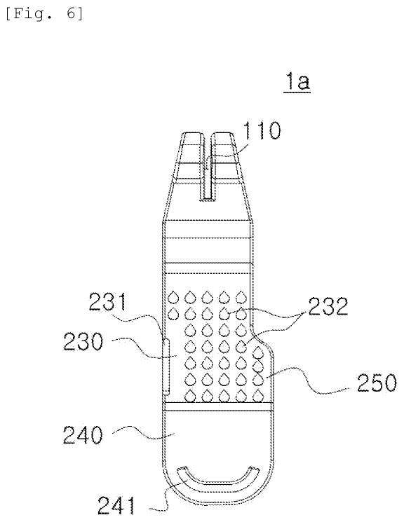

In the case of the medical opening and suction device having the second concave portions 210 and 210a and the second apertures 220 and 220a as shown in FIG. 2, if the handle portions 240 and 240a are held by the patient or dentist, they are bent inwardly, as shown in FIG. 5.

In this case, a distance between the mounting portions 230 and 230a and a distance between the handle portions 240 and 240a are decreased, so that the medical opening and suction device is easy to be put into the patient's mouth.

Even if the patient's mouth is somewhat open during the dental treatment or surgery, further, the medical opening and suction device does not escape from the mouth because of the elasticity generated from the second concave portions 210 and 210a and the second apertures 220 and 220a.

When it is assumed that a state where the medical opening and suction device is put into the patient's mouth to seat the patient's teeth onto the mounting portions 230 and 230a is primary biting, furthermore, even if the patient applies his or her bite force to the mounting portions 230 and 230a to thus generate secondary biting, the elasticity of the mouth opening part 1 is kept by means of the second concave portions 210 and 210a and the second apertures 220 and 220a.

Like this, the medical opening and suction device having the elasticity includes the second body 200 with the second concave portions 210 and 210a and the second apertures 220 and 220a, and accordingly, even if biting occurs by the teeth seated onto the mounting portions 230 and 230a, the elasticity is generated from the second body 200 to advantageously prevent the mounting portions 230 and 230a from being broken.

The mouth opening part 1 as explained in the first embodiment of the present invention may be a fixed type mouth opening part because it does not have any elasticity, and the mouth opening part 1 as explained in the second embodiment of the present invention may be a flexible mouth opening part because it has elasticity.

### Third Embodiment

The medical opening and suction device according to the first or second embodiment of the present invention further includes extending portions 250 and 250a on the mouth opening part 1.

Accordingly, the medical opening and suction device according to the third embodiment of the present invention is the same as according to the first or second embodiment of the present invention, except the extending portions 250 and 250a, and therefore, repeated explanations will be omitted.

As shown in FIG. 6, the extending portions 250 and 250a extend from one side of the mounting portions 230 and 230a and the handle portions 240 and 240a in longitudinal directions.

In this case, as the handle portions 240 and 240a extend, the second non-slip portions 241 and 241a extend together with the handle portions 240 and 240a.

In this case, as shown in FIG. 6, areas where teeth are seated are increased by means of the extending portions 250 and 250a, and accordingly, the mouth opening part 1 is rotatable to a relatively large range in the mouth through the handle portions 240 and 240a.

The mouth opening part 1 having the extending portions 250 and 250a may be a mouth opening part 1a for adults, and the mouth opening part 1 having no extending portions 250 and 250a may be a mouth opening part for children.

If the mouth opening part for children has the extending portions 250 and 250a, it may deeply enter a child's mouth to cause vomiting or retching. Therefore, the mouth opening part for children does not need to have the extending portions 250 and 250a because children has smaller mouths than adults.

### Fourth Embodiment

The medical opening and suction device according to the second or third embodiment of the present invention further includes second protrusions 221 and 221a.

Accordingly, the medical opening and suction device according to the third embodiment of the present invention is the same as according to the second or third embodiment of the present invention, except the second protrusions 221 and 221a, and therefore, repeated explanations will be omitted.

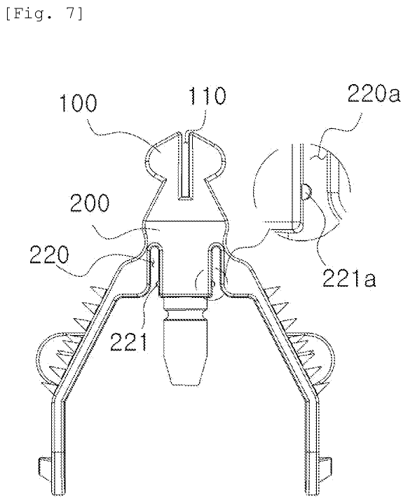

As shown in FIG. 7, the second protrusions 221 and 221a protrude outward from the second body 200 having the second apertures 220 and 220a.

In this case, as shown in FIG. 5, the second protrusions 221 and 221a serve to prevent the handle portions 240 and 240a from being excessively bent inwardly when a strong force is applied to the handle portions 240 and 240a by the patient or dentist.

### Fifth Embodiment

The medical opening and suction device according to a fifth embodiment of the present invention is configured to add a scent to the mouth opening part 1 in the first to fourth embodiments of the present invention.

In this case, the configuration of the mouth opening part 1 according to the fifth embodiment of the present invention is the same as according to the first to fourth embodiments of the present invention, except the addition of scent, and therefore, repeated explanations will be omitted.

To add a scent to the mouth opening part 1, a flavor not harmful for human body is mixed with synthetic resin, and next, the mouth opening part 1 is made of the synthetic resin by means of injection molding.

In this case, the mouth opening part 1 to which the scent is added blocks the inherent scent generated from the synthetic resin, and accordingly, he or she does not feel any reluctance when the mouth opening part 1 is put into the patient's mouth.

The scent is made of natural flavors or synthetic flavors that do not cause any rejection when the mouth opening part 1 is put into the mouth.

For example, the scent is any one of sweet scent, fruit scent, mint scent, nut scent, and grain scent, and it may not be specially limited thereto.

### Sixth Embodiment

The medical opening and suction device according to a sixth embodiment of the present invention is configured to add a color to the mouth opening part 1 in the first to fifth embodiments of the present invention.

In this case, the configuration of the mouth opening part 1 according to the fifth embodiment of the present invention is the same as according to the first to fifth embodiments of the present invention, except the addition of color, and therefore, repeated explanations will be omitted.

To add a color to the mouth opening part 1, a pigment not harmful for human body is mixed with synthetic resin, and next, the mouth opening part 1 is made of the synthetic resin by means of injection molding.

In this case, the mouth opening part 1 to which the color is added is customizedly made to have a desired color, so that it does not have any inherent color of the synthetic resin.

For example, the mouth opening part 1 to which a yellow color is added is used for children, and the mouth opening part 1 to which a blue color is added is used for adults.

In this case, the color is selected freely by the patient, without any limitation.

### Seventh Embodiment

The medical opening and suction device according to a seventh embodiment of the present invention includes a cover on the mouth opening part 1 in the first to sixth embodiments of the present invention.

In this case, the configuration of the mouth opening part 1 according to the seventh embodiment of the present invention is the same as according to the first to sixth embodiments of the present invention, except the cover, and therefore, repeated explanations will be omitted.

To prevent the patient from feeling a sensation of having foreign body in his or her mouth when the mouth opening part 1 is put into his or her mouth, the cover serves to surround the mounting portions 230 and 230a, the first support portions 231, and 231a, the handle portions 240, and 240a, and the extension portions 250, and 250a.

In this case, the cover has the shape of a cap made of silicone resin and is thus fittedly coupled to the mounting portions 230 and 230a, the first support portions 231, and 231a, the handle portions 240, and 240a, and the extension portions 250, and 250a, thereby avoiding the patient from feeling a sensation of having foreign body in his or her mouth.

### INDUSTRIAL APPLICABILITY

The easily detachable medical opening and suction device according to the present invention allows the mouth opening part adapted to hold the patient's mouth open during the dental treatment or surgery and the suction part adapted to suck saliva, water, tartar, and cut tooth pieces in the mouth to be detachably coupled to each other with ease.

1. An easily detachable medical opening and suction device comprising:
a mouth opening part (1) put in a patient's mouth to seat the patient's teeth thereonto in such a way as to hold the patient's mouth open and having a hole formed therein to suck a liquid in the mouth; and
a suction part (2) having guide portions (410) whose one end detachably coupled to the other end of the mouth opening part (1), a tube (T) coupled to the other end of the guide portions (410), and a suction unit coupled to the other end of the tube (T) to provide a suction force,
wherein the mouth opening part (1) comprises:
a first body (100) having first concave portions (120 and 120a) onto which occlusal surfaces are locked and a first aperture (110) to which the liquid is sucked;
a second body (200) extending from the other end of the first body (100) and having mounting portions (230 and 230a) onto which the teeth are seated, first support portions (231 and 231a) protruding from the side surfaces of the mounting portions (230 and 230a) and located between a teeth arrangement and the buccal mucosa, and handle portions (240 and 240a) extending from the mounting portions (230 and 230a); and
a third body (300) having a coupling groove (310) to which the suction part (2) is detachably coupled.

2. (canceled)

3. The medical opening and suction device according to claim 1, wherein the mouth opening part (1) comprises second concave portions (210 and 210a) formed between the first body (100) and the second body (200) and second apertures (220 and 220a) formed on the second body (200) to thus apply elasticity to the handle portions (240 and 240a).

4. The medical opening and suction device according to claim 1, wherein the mounting portions (230 and 230a) have first non-slip portions (232 and 232a) protruding therefrom to prevent the teeth from slipping therefrom.

5. The medical opening and suction device according to claim 1, wherein the handle portions (240 and 240a) have second non-slip portions (241 and 241a) protruding therefrom to prevent a hand holding the mouth opening part (1) from slipping therefrom.

6. The medical opening and suction device according to claim 1, wherein the mouth opening part (1) has extending portions (250 and 250a) extending from one side of the mounting portions (230 and 230a) and the handle portions (240 and 240a) to extend an area onto which the teeth are seated.

7. (canceled)
